(19) United States
(12) Patent Application Publication
(10) Pub. No.: US 2017/0347688 A1
(43) Pub. Date: Dec. 7, 2017

(54) CITRUS-DERIVED LIQUID COMPOSITION

(71) Applicant: Suntory Holdings Limited, Osaka-shi, Osaka (JP)

(72) Inventor: Akiyuki Yokoyama, Osaka-shi, Osaka (JP)

(73) Assignee: Suntory Holdings Limited, Osaka-shi, Osaka (JP)

(21) Appl. No.: 15/539,016

(22) PCT Filed: Dec. 22, 2015
(86) PCT No.: PCT/JP2015/085782

§ 371 Date: Jun. 22, 2017

(30) Foreign Application Priority Data
Dec. 26, 2014 (JP) 2014-266249

(51) Int. Cl. A23L 2/06

(52) U.S. Cl. CPC A23L 2/06; A23V 2002/00

(57) ABSTRACT

A liquid composition obtained by subjecting a fruit peel part of a citrus fruit with a cut space of from 0.5 to 5.0 mm on a surface to extraction in a solvent, the liquid composition containing an aroma component and a bitterness component; a container-packed beverage obtainable by mixing a liquid composition as defined above and a raw material for a beverage; and a method for producing a liquid composition, including subjecting a fruit peel part of a citrus fruit with a cut space of from 0.5 to 5.0 mm on a surface to extraction in a solvent, thereby preparing a liquid composition, the liquid composition containing an aroma component and a bitterness component of the citrus fruit. The foodstuff using the liquid composition of the present invention have “crispness” and “freshness” of the citrus fruit, so that the foodstuff can provide new tastes as luxurious products.

### TECHNICAL FIELD

The present invention relates to a liquid composition derived from a citrus fruit. More specifically, the present invention relates to a liquid composition containing a fruit peel-derived component from a citrus fruit and a method for producing the same, and foodstuff containing the liquid composition.

### BACKGROUND ART

Citrus fruits are lemons, limes, grapefruits, tangerines, mandarins, hassaku oranges, etc., which are very popular as raw materials for foodstuff such as fruit beverages because of refreshing aroma and sweet-acid taste owned by the citrus fruits. Especially in alcoholic beverages chuhai (shochu-based beverage), alcoholic beverages that are flavored with citrus fruits characterized by crisp flavor hold the majority of the market shares.

In the quality design for citrus fruit-taste alcoholic beverages, although the quality of the raw materials obtained from the fruits is important, the quality of the aroma is also comparably important. For example, numerous techniques in which citrus fruit pulp or fruit peel is used as an aromatizing material for citrus fruit taste have been developed.

As a method of using the fruit peel itself, for example, Patent Publication 1 discloses that even after fruit peel of a citrus fruit is blended in the form of a crushed product, and the fruit beverage is processed as a container-packed fruit beverage, it is possible to stably retain “after-bitterness” in which the bitterness is felt continuously after drinking so that the bitterness is effectively given to the fruit juice, thereby producing a fruit beverage rich in flavors that take advantage of a faint “bitterness.”

In addition, as a method utilizing extraction of a specified component from fruit peels, Patent Publication 2 reports a technique of using a liquid component as a raw material for alcoholic beverages, which the liquid component is produced when flavedo parts are peeled off from the fruit peels of a citrus fruit, so as not to contain the albedo parts as much as possible without breaking down internal oil glands, and thereafter the flavedo parts were crushed in a water-containing alcohol. The crushing method used in this method includes a method of finely mincing with a kitchen knife, or a method using a household mixer or a triturator.

Patent Publication 3 discloses that “a grapefruit cold-pressed oil” obtained by subjecting fruit peels of grapefruits to a sfumatorice method in which the peels are folded, a rasping method in which surface fruit peel of fruit peels is removed, a press method in which fruit peels are squeezed and cut, etc., and then subjecting the fruit peels to an oil press at 30° C. or lower can effectively suppress unpleasant acerbity.

Patent Publication 4 reports that a component prepared by further extracting a composition prepared by extracting a peel oil from fruit peels of citrus fruits and mixing the extract with pulp cells of citrus fruits, with an alcohol can give a natural flagrance and a strong tastefulness of fruit juice.

On the other hand, the taste is deteriorated if an aroma component collected from fruit peels is added, so that a method in which a water-soluble aroma and/or an essential oil is collected and used from steam generated upon concentration of the fruit juice obtained from fruit pulps is disclosed (see, Patent Publication 5).

### RELATED ART REFERENCES

### Patent Publications

Patent Publication 1: Japanese Patent Laid-Open No. 2008-212105
Patent Publication 2: Japanese Patent Laid-Open No. 2000-350571
Patent Publication 3: Japanese Patent Laid-Open No. 2011-72242
Patent Publication 4: Japanese Patent Laid-Open No. 2010-252640
Patent Publication 5: Japanese Patent Laid-Open No. 2009-11246

### SUMMARY OF THE INVENTION

### Problems to be Solved by the Invention

In fruit peel, a peel oil containing an aroma component is present in a large amount in the form of oil glands; however, since an unpleasant bitterness component is also present in the external parts of the oil glands, when a conventional press method or rasping method etc. is used, not only the oil glands but also the parts in which the bitterness component is present would be damaged, so that the aroma component coming from the oil glands and the bitterness component coming from the external parts of the oil glands would be undesirably copresent. Further, the aroma balance of the aroma component obtained by a press method or rasping method cannot be said to be sufficiently preferable, and the desired effects of giving natural taste of citrus fruits are also unsatisfactory. In addition, presently produced low-alcoholic beverages from a citrus fruit pursuing fruity tastes are chiefly adding a flavor with fruit juice, so that natural fruity tastes are not satisfactory, or on the other hand, the liquor tastes are unsatisfactory in a case where relatively large amounts of fruit juice are used, thereby making it difficult to satisfy both liquor tastes and natural fruity tastes.

An object of the present invention is to provide a liquid composition capable of giving satisfaction as a liquor while giving a natural taste of citrus fruits, and a method for producing the same, and a container-packed alcohol beverage containing the liquid composition.

### Means to Solve the Problems

Therefore, as a result of intensive studies, the present inventors have found that a liquid composition obtained by cutting the fruit peel parts of a citrus fruit with a specified cut space and subjecting the cut fruit peel parts to extraction is rich in the aroma component while controlling the bitterness component; therefore, if the liquid composition obtained is blended with foodstuff, a natural taste from citrus fruits can be given. The present invention has been perfected thereby. The effects as mentioned above are assumed to be obtained by controlling a cut space to a specified value so that the cut lines go through greater areas in the oil gland parts and but less in the external parts of the oil glands.

Specifically, the present invention relates to the following [1] to [3]:

[1] A liquid composition obtainable by subjecting a fruit peel part of a citrus fruit with a cut space of from 0.5 to 5.0 mm on a surface to extraction in a solvent, the liquid composition containing an aroma component and a bitterness component.
[2] A container-packed beverage obtainable by mixing a liquid composition as defined in the above [1] and a raw material for a beverage.
[3] A method for producing a liquid composition, including subjecting a fruit peel part of a citrus fruit with a cut space of from 0.5 to 5.0 mm on a surface to extraction in a solvent, thereby preparing a liquid composition containing an aroma component and a bitterness component of the citrus fruit.

### Effects of the Invention

The liquid composition of the present invention is excellent in that the liquid composition contains rich in the aroma component while controlling the bitterness component, so that the foodstuff obtained by using the liquid composition exhibit some excellent effects that natural tastes of citrus fruits can be given more than those of the conventional techniques.

### BRIEF DESCRIPTION OF THE DRAWINGS

FIG. 1 is a set of diagrams schematically showing one embodiment of performing solvent extraction from cuts provided on the surface of the fruit peel part of the citrus fruit.

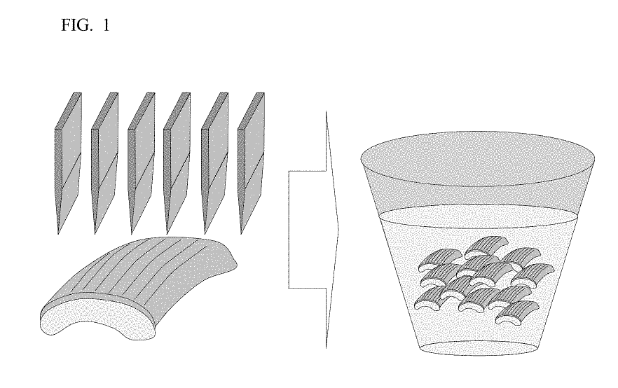

### MODES FOR CARRYING OUT THE INVENTION

The liquid composition of the present invention has some features that the liquid composition is obtainable by subjecting a fruit peel from a citrus fruit with a cut space of from 0.5 to 5.0 mm on a surface to extraction in a solvent, the liquid composition containing an aroma component and a bitterness component. In other words, the present invention is based on the findings for the first time that when a liquid composition is obtained by performing a solvent extraction from the surface of the fruit peels of a citrus fruit which was cut with a specified space, the liquid composition containing an aroma component limonene and a bitterness component naringin and/or hesperidin in a specific mass ratio can be obtained, and that the foodstuff containing the liquid composition can satisfy a liquor taste while having natural tastes from citrus fruits.

The citrus fruits in the present invention are general names of plants belonging to Aurantiodeae of Rutaceae, and, for example, lemons, grapefruits (white, ruby), limes, oranges (Citrus sinensis) (navel oranges, Valencia oranges), unshiu orange (Citrus unshiu), tangors, natsumikan (Citrus natsudaidai), amanatsu (Citrus natsudaidai f. tananonatsudaidai), hassaku orange (Citrus hassaku), hyuganatsu (Citrus tamurona), flat lemon (Citrus depressa), sudachi (Citrus sudachi), yuzu (Citrus junos), kabosu (Citrus sphaerocarpa), daidai (Citrus aurantium), iyokan orange (Citrus iyo), ponkan (Citrus reticulate var. poonensis), Japanese kinkan, sanbokan (Citrus sulcata), oroblanco, or Japanese buntan (Citrus maxima) can be suitably used. In particular, one or more members selected from the group consisting of grapefruits, lemons, yuzu, mandarins, and tangerines are preferred.

The fruit peel part of the citruses may be any that contains fruit peel. Specifically, the fruit peel part may be in a state of fruit peel alone, or in a state that fruit pulps are present on the fruit peel, containing fruit peel and fruit pulps, without fractionation to take out the fruit peel from the fruit pulps. Also, a whole fruit may be used. Preferably, a flavedo part is used. The thicknesses of the fruit peel cannot be unconditionally set because they widely vary depending upon the kinds of the citrus fruits, and the thickness may be a thickness that includes a flavedo part. Here, before forming some cuts, the fruit peel part may be washed, for example, washed under running water and used. The fruit peel and the fruit itself may be raw (without undergoing freezing etc. after harvest) or in a frozen state or a thawed state.

The cuts to be formed on the surface of the fruit peel part of a citrus fruit refers to recess parts formed on the surface of the fruit peel part, and includes any of the recess parts that are formed continuously or discontinuously. For example, the recess parts may be grooves linearly formed, or spotted in a dotted line form, or formed in a wavy form, a curve form, a solid line form, etc. Accordingly, the cut space as used herein is a distance between one recess part and another recess part (space), for example, a distance between an end part of one recess part and an end part of an adjoining other recess part closest to the one recess part.

Specifically, the recess parts may be formed so that a space between the recess part and the adjoining recess part is from 0.5 to 5.0 mm. The distance is preferably 4 mm or less, more preferably 3 mm or less, and even more preferably 2 mm or less, from the viewpoint of flavoring. Here, the space as used herein means an average space in a case where plural recess parts are present. The length as used herein can be measured, for example, with a microscope equipped with a distance measurement function.

The width of the cut parts (width of the recess parts) is not particularly limited so long as the recess parts are formed so as to have the space as defined above, and the width is preferably 2 mm or less, more preferably 1 mm or less, and even more preferably 0.1 mm or less, from the viewpoint of flavoring. Although the lower limit is not particularly limited, the width is preferably 0.04 mm or more. Here, in a case where the recess part has a length and a breadth, it is preferable that at least one of them satisfies the length defined above, and both of them do not have to necessarily have the length defined above. Here, the width as used herein means an average width when plural recess parts are present.

The depth of the recess parts cannot be unconditionally set, because the thicknesses of fruit peels widely vary depending upon the kinds of the citrus fruits, so that the depth is preferably 0.1 mm or more, and preferably 3.0 mm or less, more preferably 1.5 mm or less, and even more preferably 1 mm or less, from the viewpoint of flavoring. Here, the depth of the recess parts refers to an orthogonal distance from the surface of the fruit peel part of flavedo side to a deepest part of the recess part. Although there are some differences in thicknesses of flavedo and albedo depending upon the fruits, if the recess parts are made only in the flavedo of the surface so that the recess parts are made in the albedo parts as little as possible, extraction of the bitterness is controlled, so that more preferred flavor is obtained. Here, the depth as used herein means an average depth when plural recess parts are present.

The shape of the recess parts is not particularly limited, and a cross-sectional shape at a side intersecting orthogonally to the length includes, for example, V-shaped form, U-shaped form, etc.

The method of forming recess parts of the above shape on the surface of fruit peel parts includes, but not particularly limited to, for example, a method using a cutter blade etc. in which plural blades are set with spacers intervening between blades so that a space between a recess part to another recess part falls within the above range. Specifically, for example, linear recess parts can be formed by pressing the cutter against the surface of the fruit peel parts mounted on a roller, and rotating the roller. During the formation, the depth of the recess parts can be controlled by adjusting a space between the cutter blade and the roller, and the recess parts can be formed into a V-shaped form or a U-shaped form depending upon the shapes of the blades. One of ordinary skill in the art can form recess parts using blades of which shape is in a curved form, a solid line form, a dotted line form, a combined form of plural lines, a circular or oval form, etc., and/or two or more combinations thereof, according to the teachings of the present invention, depending upon the shapes or rigidness of the fruit peel part and the production speed of the facility. In addition, the method of putting the blades to the fruit peel parts can be selected from a press method (pushing from one direction), a rotating method (blade is rotated and pressed against the fruit peel parts running over a belt conveyor etc. from an upstream step to a downstream step), etc.

As described above, the cuts can be formed with a specified space on the surface of the fruit peel parts. The surface of the fruit peel parts obtained may be any that has a cut space as defined above, and the degree of forming the cuts may be, for example, in a case of a linear blade, a recess part having an area of [width of the cuts with the blade: 0.04 to 0.1 mm (preferably from 0.05 to 0.09 mm, and more preferably from 0.06 to 0.08 mm)]×[cut space: 0.5 to 5.0 mm (preferably from 0.5 to 3.0 mm, and more preferably from 0.5 to 1.0 mm), i.e. the number of cuts: 20 to 200 (preferably from 33 to 200, and more preferably 100 to 200) per 100 mm]×[length: 100 mm], per surface of the fruit peels (width) 100 mm×(length) 100 mm, may be formed. In other words, the cut area with the blade (total areas of the recess parts) is preferably 80 mm² or more, more preferably 100 mm² or more, even more preferably 150 mm² or more, and even more preferably 200 mm² or more, and the cut area is preferably 2,000 mm² or less, more preferably 1,800 mm² or less, and even more preferably 1,500 mm² or less, per surface of the fruit peels (width) 100 mm×(length) 100 mm. In the present invention, it is preferable that the cuts to a degree of having the above area are formed in a case where the shape of the blade is not only linear, but also in a curved form, a solid line form, a dotted line form, a combined form of plural lines, a circular or oval form, and/or two or more forms thereof in combination.

Thus, the fruit peel surface having a specified cut space is obtained. The fruit peel parts obtained are subjected to extraction with a solvent so that an oil in the oil glands is extracted, whereby a liquid composition having a specified flavor component in a specified proportion is obtained.

As the solvent usable in the extraction in the present invention, a liquid containing one or more members selected from the group consisting of water, ethanol, edible fats and oils, carbon dioxide liquefied gas, propylene glycol, glycerol, acetone, nitrous oxide, ethyl methyl ketone, ethyl acetate, methyl acetate, diethyl ether, cyclohexane, dichloromethane, 1,1,2-trichloroethene, 1,1,1,2-tetrafluoroethane, 1-butanol, 2-butanol, butane, 1-propanol, 2-propanol, propane, hexane, and methanol is preferred. For example, in a case where a water-containing ethanol is used as a solvent, the liquid composition obtained falls under spirits, distilled liquor, liqueur, infused liquor or the like. In addition, it is preferable that the ethanol concentration is preferably from 10% to 99.5% (volume/volume), more preferably from 20% to 60%, and even more preferably from 30% to 50%.

The amount of the solvent used is, but not particularly limited thereto, preferably from 1 to 100 times the mass, more preferably from 1 to 10 times the mass, and even more preferably from 1 to 5 times the mass, based on the mass of the fruit peel parts.

The extraction time is preferably 60 minutes or less, and more preferably 10 minutes or less, from the viewpoint of controlling the extraction of the bitterness component. Although the lower limit is not particularly limited, it is preferable that the extraction time is 0.5 minutes or longer. In addition, the extraction temperature is, but not particularly limited thereto, for example, preferably from 0° to 30° C. The extraction procedures can be carried out according to a known technique, which may be immersion extraction or agitation extraction. For example, the surface of the fruit peel parts may be cut, and extracted with a solvent, before a fruit squeezing step with an in-line type squeezing machine manufactured by John Bean Technologies (formerly FMC).

The extract obtained may be directly used as a liquid composition of the present invention, or may be properly diluted with a solvent such as a water-containing alcohol and used as a liquid composition of the present invention.

Thus, the liquid composition of the present invention is obtained. The liquid composition of the present invention contains an aroma component and a bitterness component of the citrus fruits. For example, in a case of grapefruits, it is preferable that the aroma component of the citrus fruits is limonene, and that the bitterness component is naringin, wherein the content mass ratio thereof (limonene/naringin) is 1.7 or more. Alternatively, in a case of lemons, it is preferable that the aroma component of the citrus fruits is limonene, and that the bitterness component is hesperidin, wherein the content mass ratio thereof (limonene/hesperidin) is 1.7 or more. Here, the content mass of each of the components in the liquid composition of the present invention is not particularly limited, so long as the content mass ratio of the above components are within the range defined above, which can be properly adjusted by the extraction conditions.

When the liquid composition of the present invention is obtained by using a fruit peel containing mainly naringin as a bitterness component, a content mass ratio of limonene to naringin (limonene/naringin) is preferably 1.7 or more, and from the viewpoint of flavoring, the content mass ratio is more preferably 2.5 or more. The higher this ratio, the more controlled the bitterness, making the aroma favorable.

When the liquid composition of the present invention is obtained by using a fruit peel containing mainly hesperidin as a bitterness component, a content mass ratio of limonene to hesperidin (limonene/hesperidin) is preferably 1.7 or more, from the viewpoint of flavoring. Similarly, the higher the ratio, as in the ratio of limonene to naringin, the more controlled the bitterness, making the aroma favorable.

Since the liquid composition of the present invention has a controlled bitterness and excellent aroma, one embodiment of the present invention provides a flavoring agent obtainable by subjecting a fruit peel part of a citrus fruit with a cut space of from 0.5 to 5.0 mm on a surface to extraction in a solvent, the flavor agent containing an aroma component and a bitterness component of the citrus fruit. The flavoring agent of the present invention is obtained in the same manner as a liquid composition of the present invention, and components contained therein, content mass ratios of the components, etc. are as mentioned above.

In addition, the present invention provides a method for producing a liquid composition of the present invention including subjecting a fruit peel part of a citrus fruit with a cut space of from 0.5 to 5.0 mm on a surface to extraction in a solvent, thereby preparing a liquid composition containing an aroma component and a bitterness component of the citrus fruit. The kinds of the raw materials and amounts used in the above step and the method for preparation thereof can be referred to the description in the section of the liquid composition of the present invention. There are no particular limitations other than the above step, and concentration or dilution may be carried out according to a known technique. An embodiment further including removing the extraction solvent is preferred.

The present invention also provides foodstuff obtainable by mixing a liquid composition of the present invention with raw materials for foodstuff.

The container packed foodstuff of the present invention are not particularly limited so long as the liquid composition of the present invention is contained. As the foodstuff of the present invention, for example, when a container-packed beverage is produced, fruit juice derived from a citrus fruit and a given amount of a liquid composition of the present invention are added to raw materials for beverages, and mixed with other optional components, optionally diluted with a beverage not containing an alcohol such as water, and packed in a container, whereby the container-packed beverages can be produced.

The content of the liquid composition of the present invention in the foodstuff of the present invention is such that the amount of limonene is preferably from 1 ppb to 200 ppm, and more preferably from 10 ppb to 150 ppm.

In the production of the foodstuff of the present invention, as a raw material for foodstuff, for example, in a case of a raw material for beverages, an alcohol (i.e. ethyl alcohol) itself can be used, or a beverage containing an alcohol can also be used as a raw material containing alcohol (alcohol raw material). The alcohol raw material refers to a liquid containing ethyl alcohol.

The alcohol raw material which can be utilized in the present invention is not particularly limited, so long as it is an alcohol-containing liquid suitable for drinking. The alcohol raw material can be obtained by sugar alcohol fermentation with an yeast. The raw material for alcohol fermentation includes, but not particularly limited to, fruits such as grapes, apples, cherries, and coconuts, grains such as rice, barley, and maize, root crops such as white potatoes and sweet potatoes, and sugar canes, etc.

The alcohol raw material includes, for example, brewed liquors, distilled liquors, and mixed liquors of distilled liquors, etc. The distilled liquors include, for example, spirits (e.g., spirits such as gin, vodka, rum, and tequila, alcohols for raw materials etc.), liqueurs, whiskeys (e.g., whiskeys, brandies, etc.) and shochu (continuous distilled shochu and single distilled shochu), etc., and these can be used alone or in a combination of two or more kinds. The brewed liquors include, for example, sake, wines, beer, etc.

Since it is preferable that the foodstuff of the present invention have a refreshing feel of aroma, it is preferable to use a distilled liquor as an alcohol raw material. In particular, distilled liquors having crisp quality with less aroma, such as spirits such as vodka and alcohols for raw materials, and continuous distilled shochu are preferred.

The fruit juice derived from citrus fruits is not particularly limited so long as the fruit juice is obtained in accordance with a known method, which may be in forms of straight fruit juice in which fruit juice obtained by squeezing fruits is directly used, concentrated fruit juice in which fruit juice is concentrated, or fruit juice in which a part or whole of the above fruit juice is subjected to clarification treatment (translucent fruit juice or semitranslucent fruit juice). In a case of an alcoholic beverage as the foodstuff of the present invention, the content of the citrus fruit juice in the alcoholic beverage of the present invention is, as calculated by fruit juice percentage, for example, from 1 to 99 w/w (mass/mass) %. The “fruit juice percentage” as referred to herein is a relative concentration when straight juice obtained by squeezing fruits is defined as 100%, which can be calculated based on the standards for sugar refractive index (Bx) or the standard of acidity (%) distinctively owned by each fruit, shown in the JAS standard (the Japanese Agricultural Standard for fruit beverages). For example, according to the JAS standard, the standard Bx for apples is 10 degrees; therefore, for example, apple juice having Bx of 70 degrees is an apple juice of a 7 times concentrate.

In the present application, the calculation of the fruit juice concentration contained in the alcoholic beverage by a relative concentration when straight fruit juice is defined as 100% according to the analysis and calculation is called “calculated based on straight.”

As the citrus fruit juice which can be used in the present invention, the above citrus fruits can be used without particular limitations, which may be identical or different from the citrus fruit used in the preparation of the liquid composition of the present invention. These citrus fruit juices may be used alone or in a combination of two or more kinds, and other kinds of fruit juices can be blended therewith. For example, apple juice, grape juice, peach juice, tropical fruit juices (pineapple, guava, banana, mango, acerola, papaya, passion fruit, and lychee, etc.), and juices of other fruits (Japanese apricot (Prunus mume) juice, Nashi pear (Pyrus pyrifolia var. culta) juice, apricot (Prunus armeniaca) juice, Japanese plum (Prunus salicina) juice, berry juice, kiwi juice, cherry juice, and chestnut juice, etc.), watermelon juice, tomato juice, carrot-fruit juice, strawberry juice, and melon juice, etc. may be blended therewith.

The foodstuff of the present invention can be blended with other components, for example, a sugar, an acid, a flavor, vitamins, pigments, an antioxidant, an acidulant, an emulsifier, a preservative, a seasoning, an extract, a pH adjustment agent, and a quality stabilizer, etc.

In order to increase a refreshing feel of the alcoholic beverage, when an alcoholic beverage is prepared as the foodstuff of the present invention, it is preferable that a carbon dioxide gas is blended. Therefore, an alcoholic beverage of shochu and carbonated water is also embraced in the scope of the present invention. The gas pressure of the carbon oxide gas of the alcoholic beverage of the present invention, when the temperature of the beverage is 20° C., is preferably 0.8 kgf/cm² or more, and more preferably within range of from 0.8 to 3.1 kgf/cm², and the gas pressure can be properly adjusted. The alcoholic beverage of the present invention blended with a carbon dioxide gas includes the form which is so-called chuhai. In the present invention, the pressure of the carbon dioxide gas can be measured with a gas volumetric apparatus GVA-500A manufactured by Kyoto Denshi Kogyo. The pressure of carbon dioxide gas is measured by, for example, controlling a sample temperature to 20° C., degassing (sniffed) in the air inside the vessel in the above gas volumetric apparatus, and then shaking. In the present specification, the pressure of carbon dioxide gas means a pressure of carbon dioxide gas at 20° C. of a sample temperature unless specified otherwise.

The alcohol concentration when an alcoholic beverage is prepared as the foodstuff of the present invention is an alcohol concentration at which consumers favorably drink as a malt fermented beverage such as beer or happoshu, or a liqueur, or spirits, i.e. within a range of from 1 to 50% (v/v).

The alcohol beverage of the present invention can be provided as a container-packed beverage by filling an alcoholic beverage in a sealed container such as a glass bottle, a tin can, a barrel, or a plastic bottle, in the same manner as in an ordinary beverage.

### EXAMPLES

The present invention will be described hereinbelow specifically by means of Examples, without intending to restrict the present invention to those following Examples.

[Measurement of Naringin and Hesperidin]

A sample liquid composition is diluted 10 times with a 59% aqueous alcohol solution, and then filtered with a filter (0.45 μm), and the filtrate is subjected to HPLC analysis. The analytical conditions of HPLC are as follows.

### HPLC Apparatus: Agilent Technologies 1200 Series

Column: Shimadzu phenomenex kinetex 2 to 6μ C18 100A
150×2.10 mm

### Column Temperature: 40° C.

Mobile Phase A: Water-0.1% formic acid
Mobile Phase B: Water-12% acetonitrile
Mobile Phase C: Water-70% methanol

### Detection: UV at 280 nm

### Injected Amount: 1 μL

Standard substances: Naringin and hesperidin

TABLE 1
Gradient Program

| Time | | | | Flow Rate |
|---|---|---|---|---|
| (minute) | A(%) | B(%) | C(%) | (ml/min) |
| 0 | 88 | 12 | 0 | 0.35 |
| 1 | 88 | 12 | 0 | 0.35 |
| 2 | 80 | 20 | 0 | 0.35 |
| 3 | 40 | 60 | 0 | 0.35 |
| 4 | 0 | 100 | 0 | 0.35 |
| 5 | 0 | 100 | 0 | 0.35 |
| 6 | 0 | 0 | 100 | 0.20 |
| 7 | 0 | 0 | 100 | 0.20 |
| 8 | 88 | 12 | 0 | 0.20 |
| 9 | 88 | 12 | 0 | 0.35 |

[Measurement of Limonene]

A sample liquid composition is subjected to gas chromatography mass spectroscopy (GC-MS) under the following conditions. The analytical conditions are as follows.

### GC Apparatus: Agilent Technologies GC-MSD

Conditions for GC Oven Temperature: 40° C. (5 minute)-6° C./min-240° C.

### Conditions for Mass Spectroscopy (MS)

Quadrupole Set Value: 150, Ion Source Set Value: 230
Conditions for Calculating Areal Value
Total Ion Mode Mass (LOW): 35, Mass (HIGH): 550
   Column: DB-WAXETR 60 m, inner diameter: 320 μm, film thickness: 0.25 μm
Conditions for Pretreatment of Sample: Eighty microliters of the sample and 20 μL of an internal standard substance (aqueous alcohol solution containing 20 ppm of methyl decanoate) are mixed in a 20 mL screw capped vial.
Dynamic Headspace Conditions
   Apparatus: GERSTEL MPS
   Adsorbent: TENAX
   Sample Gasifying Temperature: 80° C.
   Amount of Supplied Gas for Sample Gasification: 3000 ml
   Rate of Supplied Gas for Sample Gasification: 100 ml/min
   Kinds of Gas for Sample Gasification: Nitrogen
      Peak Retention Time: The components and concentrations were identified according to the analysis of MS.

### Standard Substance: Limonene

### Test Example 1 (Grapefruits)

A liquid composition of grapefruits was prepared as follows. Fruit pulp was removed, and fruit peels (including flavedo and albedo) which were cut to sizes of about 1 cm×5 cm were furnished. Cuts were made in a width of from 0.5 to 5.0 mm on the surface of the fruit peels at a flavedo side with a bladed instrument having a thickness of 0.1 mm. A depth of the cuts was a depth of 0.5 to 3.0 mm from the flavedo surface.

After cutting, 3.5 g of the fruit peels were immersed in 15 mL of a 59 v/v % aqueous ethanol solution for one minute, to allow extraction. The fruit peels were removed therefrom after one minute, and this provided a liquid composition.

A liquid composition obtained in an amount of 0.1 v/v % was added to a 5 v/v % aqueous alcohol solution containing grapefruit juice, to prepare an alcoholic beverage. The flavors of the alcoholic beverage obtained and the liquid composition itself were evaluated by a sensory test according to a scoring method. Well trained persons made a comprehensive evaluation on “crispness” and “freshness” in a relative evaluation using a beverage obtained by a liquid composition prepared from fruit peels without cuts on the surface as a control (Comparative Example 1), where a full score is score 5 based on the control. The score evaluations were as follows: “Feeling very much or very good” is “4,” “feeling some or good” is “3,” “feeling slightly or bit good” is “2,” and “control” is “1.” The results are shown in Table 2.

TABLE 2

| | Space | Depth | | | | Sensory | |
|---|---|---|---|---|---|---|---|
| | of | of | | | | Evaluation | |
| | Blades | Blade | D-Limonene | Naringin | D-Limonene/ | Liquid | |
| | (mm) | (mm) | (ppm) | (ppm) | Naringin | Composition | Beverage |
| Ex. 1 | 0.5 | 1.5 | 102 | 27.6 | 3.7 | 3 | 3 |
| Ex. 2 | 1.0 | 0.5 | 73 | 17.8 | 4.1 | 4 | 4 |
| Ex. 3 | 1.0 | 1.5 | 87 | 24.5 | 3.6 | 4 | 4 |
| Ex. 4 | 1.0 | 3.0 | 91 | 35.3 | 2.6 | 2 | 2 |
| Ex. 5 | 2.0 | 1.5 | 76 | 25.3 | 3.0 | 3 | 3 |
| Ex. 6 | 3.0 | 1.5 | 64 | 17.5 | 3.6 | 3 | 3 |
| Ex. 7 | 4.0 | 1.5 | 68 | 27.6 | 2.5 | 2 | 2 |
| Ex. 8 | 5.0 | 1.5 | 53 | 28.5 | 1.9 | 2 | 2 |

| | | | | | | |
|---|---|---|---|---|---|---|
| Comp. | Without cuts | 9 | 11.3 | 0.8 | 1 | 1 |
| Ex. 1 | on surface | | | | | |

From Table 1, the beverages of Examples in which liquid compositions extracted from fruit peel parts with cuts on the surface in a specified space were used as raw materials are excellent in the sensory evaluation. Among them, it can be seen that Examples 2 and 3 where content ratios of limonene to naringin are 4.1 and 3.6 had even more excellent “crispness” and “freshness.”

### Test Example 2 (Lemons, Yuzu, Tangerines, and Mandarins)

A liquid composition of lemon was prepared as follows. Fruit pulp was removed, and fruit peels (including flavedo and albedo) cut to sizes of about 1 cm×5 cm were furnished. Cuts were made on the surface of the fruit peels at a flavedo side with a bladed instrument having a thickness of 0.1 mm, in a width and a depth as listed in Table 3. After cutting, 3.5 g of fruit peels were immersed in 15 mL of a 59 v/v % aqueous ethanol solution for one minute, to allow extraction. The fruit peels were removed therefrom after one minute, and this provided a liquid composition. As to yuzu, tangerine, and mandarin, cuts were made on the surface of the fruit peels at a flavedo side to an extent of a thickness of the flavedo in a width and a depth in the same manner (see, Tables 4 to 6).

As to lemon, a liquid composition obtained in an amount of 0.1 v/v % was added to 5 v/v % aqueous alcohol solution containing lemon juice, to prepare a beverage. In addition, as to yuzu, tangerine or mandarin, a liquid composition obtained in an amount of 0.1 v/v % was added to a 5 v/v % aqueous alcohol solution containing high-fructose corn syrup (10 g/100 mL) and citric acid (4.7 g/100 mL), to prepare a beverage. The flavors of the beverages obtained and the liquid compositions themselves were evaluated in the same manner as in Test Example 1. The results for lemon are shown in Table 3, the results for yuzu are shown in Table 4, the results for tangerine are shown in Table 5, and the results for mandarin are shown in Table 6, respectively.

TABLE 3

| | Space | Depth | | | | | |
|---|---|---|---|---|---|---|---|
| | of | of | | | | Sensory Evaluation | |
| | Blades | Blade | D-Limonene | Hesperidin | D-Limonene/ | Liquid | |
| | (mm) | (mm) | (ppm) | (ppm) | Hesperidin | Composition | Beverage |
| Ex. 9 | 1 | 1.5 | 64.5 | 1.2 | 53.7 | 4 | 4 |
| Ex. 10 | 4 | 1.5 | 4.2 | 2.2 | 1.9 | 2 | 2 |

| | | | | | | |
|---|---|---|---|---|---|---|
| Comp. | Without cuts on | 0.9 | 1.2 | 0.9 | 1 | 1 |
| Ex. 2 | surface | | | | | |

TABLE 4

| | Space of | Depth of | Sensory Evaluation | |
|---|---|---|---|---|
| | Blades | Blade | Liquid | |
| | (mm) | (mm) | Composition | Beverage |
| Ex. 11 | 1 | 1.5 | 4 | 4 |
| Ex. 12 | 4 | 1.5 | 2 | 2 |

| | | | |
|---|---|---|---|
| Comp. Ex. 3 | Without cuts on surface | 1 | 1 |

TABLE 5

| | Space of | Depth of | Sensory Evaluation | |
|---|---|---|---|---|
| | Blades | Blade | Liquid | |
| | (mm) | (mm) | Composition | Beverage |
| Ex. 13 | 1 | 1.5 | 4 | 4 |
| Ex. 14 | 4 | 1.5 | 2 | 2 |

| | | | |
|---|---|---|---|
| Comp. Ex. 4 | Without cuts on surface | 1 | 1 |

TABLE 6

| | Space of | Depth of | Sensory Evaluation | |
|---|---|---|---|---|
| | Blades | Blade | Liquid | |
| | (mm) | (mm) | Composition | Beverage |
| Ex. 15 | 1 | 1.5 | 4 | 4 |
| Ex. 16 | 4 | 1.5 | 2 | 2 |

| | | | |
|---|---|---|---|
| Comp. Ex. 5 | Without cuts on surface | 1 | 1 |

It could be seen from the results of Tables 3 to 6 that the beverages of Examples where the liquid compositions extracted from the fruit peel parts of lemon, yuzu, tangerine, and mandarin with cuts in a specified space on the surface were used as raw materials had crisp and fresh flavors without bitterness, in the same manner as in the results of grapefruits. In addition, the higher the ratio of the aroma component (D-Limonene) of the citrus fruit based on the amount of the bitterness component polyphenol (Hesperidin), the better flavor was obtained. It could be seen that lemon, mandarin, and tangerine with cuts at a space of from 1 to 4 mm similarly showed favorable results as in the grapefruit.

### INDUSTRIAL APPLICABILITY

The foodstuff using the liquid composition of the present invention have “crispness” and “freshness” of the citrus fruit, so that the foodstuff can provide new tastes as luxurious products.

1. A liquid composition obtainable by subjecting a fruit peel part of a citrus fruit with a cut space of from 0.5 to 5.0 mm on a surface to extraction in a solvent, the liquid composition containing an aroma component and a bitterness component of the citrus fruit.

2. The liquid composition according to claim 1, wherein a width of the cuts with a blade is from 0.04 to 0.1 mm, and an area of the cuts with the blade is from 80 mm² to 2,000 mm² per surface of the fruit peel part (width) 100 mm×(length) 100 mm.

3. The liquid composition according to claim 1, wherein a depth of the cuts is a depth of 0.1 to 3.0 mm from the surface of the fruit peel part of a flavedo side.

4. The liquid composition according to claim 1, wherein the aroma component is limonene.

5. The liquid composition according to claim 1, wherein the bitterness component is naringin and/or hesperidin.

6. The liquid composition according to claim 4, wherein a content mass ratio of limonene to naringin (limonene/naringin) is 1.7 or more.

7. The liquid composition according to claim 4, wherein a content mass ratio of limonene to hesperidin (limonene/hesperidin) is 1.7 or more.

8. The liquid composition according to claim 1, wherein the solvent used in extraction comprises one or more members selected from the group consisting of water, ethanol, edible fats and oils, carbon dioxide liquefied gas, propylene glycol, glycerol, acetone, nitrous oxide, ethyl methyl ketone, ethyl acetate, methyl acetate, diethyl ether, cyclohexane, dichloromethane, 1,1,2-trichloroethene, 1,1,1,2-tetrafluoroethane, 1-butanol, 2-butanol, butane, 1-propanol, 2-propanol, propane, hexane, and methanol.

9. The liquid composition according to claim 1, from which the solvent in extraction is removed.

10. The liquid composition according to claim 1, wherein the fruit peel part of a citrus fruit is in a state that comprises fruit peel alone, or comprises fruit peel and fruit pulp.

11. The liquid composition according to claim 1, wherein the citrus fruit is one or more members selected from the group consisting of grapefruits, lemons, yuzu (Citrus junos), mandarins, and tangerines.

12. A container-packed beverage obtainable by mixing a liquid composition as defined in claim 1 and a raw material for a beverage.

13. A method for producing a liquid composition, comprising subjecting a fruit peel part of a citrus fruit with a cut space of from 0.5 to 5.0 mm on a surface in a solvent, thereby preparing a liquid composition comprising an aroma component and a bitterness component of the citrus fruit.

14. The method according to claim 13, wherein a depth of the cuts is a depth of 0.1 to 3.0 mm from the surface of the fruit peel part of a flavedo side.

15. The method according to claim 13, wherein the aroma component of the citrus fruit is limonene.

16. The method according to claim 13, wherein the bitterness component is naringin and/or hesperidin.

17. The method according to claim 13, wherein the solvent used in extraction comprises one or more members selected from the group consisting of water, ethanol, edible fats and oils, carbon dioxide liquefied gas, propylene glycol, glycerol, acetone, nitrous oxide, ethyl methyl ketone, ethyl acetate, methyl acetate, diethyl ether, cyclohexane, dichloromethane, 1,1,2-trichloroethene, 1,1,1,2-tetrafluoroethane, 1-butanol, 2-butanol, butane, 1-propanol, 2-propanol, propane, hexane, and methanol.

18. The method according to claim 13, further comprising removing the solvent used in extraction.

19. The method according to claim 13, wherein the fruit peel part of a citrus fruit is in a state that comprises fruit peel alone, or comprises fruit peel and fruit pulp.

20. The method according to claim 13, wherein the citrus fruit is one or more members selected from the group consisting of grapefruits, lemons, yuzu (Citrus junos), mandarins, and tangerines.
